(19) United States
(12) Patent Application Publication
(10) Pub. No.: US 2009/0276345 A1
(43) Pub. Date: Nov. 5, 2009

(54) METHOD, SYSTEM AND ARTICLE FOR DONATIONS ON MOBILE COMMUNICATION DEVICES

(76) Inventor: Bryan G. Hughes, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 12/159,777

(22) PCT Filed: Dec. 26, 2006
(86) PCT No.: PCT/US06/49199

§ 371 Date: Oct. 22, 2008

Related U.S. Application Data
(60) Provisional application No. 60/754,844, filed on Dec. 28, 2005.

(51) Int. Cl. G06Q 40/00; G06Q 30/00; G06Q 50/00; G06F 3/048

(52) U.S. Cl. 705/34; 705/39; 715/810

(57) ABSTRACT

A method, system, and computer-readable medium facilitate the making of donations on a mobile communication device. A plurality of non-profit icons is displayed on the mobile communication device. Information about the non-profits possibly including its logo and donation icons may be displayed in some embodiments. After selecting a non-profit icon, a user can make a donation of an indicated kind and amount to the non-profit represented by the icon. After pledging a monetary donation, a communications provider may collect the donation on the communication provider's bill and gives the donation to the indicated non-profit. Potential donors may be offered the option to make non-monetary donations, such as their time.

### BACKGROUND OF THE INVENTION

1. Field of the Invention

This disclosure generally relates to the making of donations on a mobile communication device.

2. Description of the Related Art

In 2004, according to the Giving USA, Americans gave $248.52 billion to charities and individuals were the largest source of the charitable giving having donated $187.92 billion, an increase of 4.1 percent over 2003. Americans also donated an estimated $272 billion worth of volunteer service at a market value of $17.55 an hour. With disasters such as Hurricane Katrina and the Dec. 26, 2004 Southeast Asia tsunami, there is a continuing need to make charitable donations both to the relief effort and other non-profits.

Traditional methods of soliciting donations to non-profits include telethons, direct mail, phone solicitation, web donations and benefit concerts. Many of these methods are costly to the non-profit, especially when the donation amount is small, and result in only a small portion of the donations actually going to charitable purposes. Moreover, many potential donors are leery of giving to non-profits that they are not familiar with especially considering headlines of scams involving charitable giving. In addition, these methods are often inconvenient for potential donors and may not result in donations when the potential donor might otherwise give a donation if asked at a different time. For example, if a non-profit calls asking for a donation during dinner or during the potential donor's favorite television show, a potential donor may be inclined not to donate at that time. Similarly, a direct mail solicitation of a donation at the beginning of a month may not be as effective as another time of the month because the potential donor may have just used most of his money to pay monthly bills. Additionally, most of these fundraising methods involve only a single non-profit and thus are inefficient as compared to methods that involve a plurality of non-profits. Finally, most of these methods lack automated methods for thanking the donor subsequent to the donation. Thus, there is a need for a method of donating using mobile communication device with the ability to give donations at any time to multiple non-profits.

Some methods have been developed to allow a person to donate using a mobile communication device. In the wake of Hurricane Katrina, Verizon Wireless teamed up with M-Qube to allow donations to the American Red Cross's Katrina relief efforts. To participate, customers sent a text message via short message service (“SMS”) to the address 2HELP using the key word “help”. After sending the message, the customer received an SMS message asking them to confirm his/her donation in the amount of $5.00. Another SMS message was sent to confirm it by sending a “Y”. Amounts could be donated in multiple of $5.00 by repeating the procedure to a maximum of $25.00 dollars. This method is cumbersome and does not allow more flexible dollar amounts. In addition, this method was limited to donating only to one non-profit, the American Red Cross.

In the same way, non-monetary donations are also needed by non-profits. Many non-profits are dependent on volunteers and need to be able to easily solicit requests for donor's time, especially when they are critically short on volunteers for an immediately upcoming project. Calling potential volunteers is extremely time consuming and labor intensive. Furthermore, it may catch potential volunteers when their calendars are not handy. Emailing volunteers may be drowned out by other email, especially spam. Many non-profits also need other donations as well (e.g. blood banks need blood donors; food banks require food donations). Thus, there is a need for a mobile communication device to make non-monetary donations as well, especially mobile communication devices that have built in calendars.

Studies on charitable giving show that there are three mantras for non-profit fundraising: people give to people they know; people give when asked; and people give for many different reasons. Non-profits know that they need to know about the reasons and the times donors give to be able to receive repeat donations. Moreover, non-profits need to make giving as convenient as possible to potential donors. By allowing donors the ability to donate on their handheld or mobile devices and making the follow through of the donation simple, non-profits will have a low-cost method of soliciting both monetary and non-monetary donations. Calendars, available in many handheld and/or mobile devices, make it easy for volunteers to see if they have the time available to volunteer for a particular project. Potential donors will also effectively be able to be asked for donations whenever the potential donors have downtime and their mobile communication device.

### BRIEF SUMMARY OF THE INVENTION

A method, system and article facilitates the making of donations on a mobile communication device. A plurality of non-profits icons is displayed on the mobile communication device. Information about the non-profits may be displayed in some embodiments of the invention. After selecting a non-profit icon, a user can make a donation of an indicated kind and amount to the non-profit represented by the non-profit icon. In some embodiments, after pledging a monetary donation, the communication provider to the mobile communication device collects the donation via the communication provider's bill and gives at least a portion of the donation to the indicated non-profit. In other embodiments, potential donors may be offered the option to make non-monetary donations, such as their time.

In one aspect, a method of making donations to a non-profit comprises: displaying a plurality of user-selectable non-profit icons on a mobile communication device to a potential donor, the non-profit icons representing respective non-profit entities; receiving an indication of a user selected non-profit icon selected from the plurality of displayed non-profit icons; displaying one or more possible donation icons representing donations to the indicated non-profit; receiving an indication of a user selected donation icon selected from the one or more possible donations; and sending an indication of the user selected donation icon and user selected non-profit icon to a donation server. Additional functionality may be available in some embodiments.

In another aspect, a computer-readable medium stores instructions for causing a mobile communication device to facilitate a donation to a non-profit, by: displaying a plurality of user selectable non-profit icons on a mobile communication device to a communication device user, the non-profit icons representing respective non-profit entities; receiving an indication of a user selected non-profit icon selected from the plurality of displayed non-profits; displaying one or more possible donation icons representing donations to the indicated non-profit; receiving an indication of a user selected donation icon selected from the one or more possible donations; and sending an indication of the user selected donation icon and user selected non-profit icon to a donation server. Additional functionality may be available in some embodiments.

In yet another aspect, a mobile computing device for making donations to non-profits comprises: a memory; means for displaying a plurality of user selectable non-profit icons to a communication device user, the non-profit icons representing respective non-profit entities; means for receiving an indication of a user selected non-profit icon from the plurality of displayed non-profit icons; means for displaying one of more possible donation icons representing donations to the indicated non-profit; means for receiving an indication of a user selected donation icon selected from the one or more possible donations; and means for sending an indication of the user selected donation icon and user selected non-profit icon to a donation server. Additional functionality may be available in some embodiments.

### BRIEF DESCRIPTION OF THE SEVERAL VIEWS OF THE DRAWINGS

In the drawings, identical reference numbers identify similar elements or steps. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1A is a schematic view of a donation computing system communicating with a number of mobile communication devices via a network, such as a cellular network, according to one illustrated embodiment.

FIG. 1B is an isometric view of a mobile communication device including a display and user input devices for implementing a user interface suitable for facilitating a donation to a non-profit according to one illustrated embodiment.

FIG. 2A is a front view of a mobile communication device displaying a plurality of non-profits.

FIG. 2B is a front view of a mobile communication device displaying one or more potential donation to the non-profit.

FIG. 2C is a front view of a mobile communication device requesting confirmation of the donation.

FIGS. 3A-3E are front views of the visual display of a mobile communication device illustrating the categorization of non-profits and the ability to make non-monetary donations.

FIGS. 4A-4C are front views of various advanced features in some embodiments of the invention.

FIG. 5 is a block diagram illustrating an embodiment of a computing system suitable for making a donation to a non-profit via a mobile communication device.

FIG. 6 is a flow diagram showing a method of making a donation according to one illustrated embodiment.

### DETAILED DESCRIPTION OF THE INVENTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. in other instances, well-known structures associated with mobile communication devices, networks including but not limited to cellular communications networks, and computing systems have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “in some embodiments,” “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Mobile communication devices include cell phones, mobile phones, satellite phones, laptops, tablet computers, palmtops, and PDAs (Palm™, Mindspring™ and Blackberry™). For the sake of clarity, a mobile phone is illustrated and described as an exemplary embodiment of the invention. Other mobile communication devices may have different input devices and methods well known in the art.

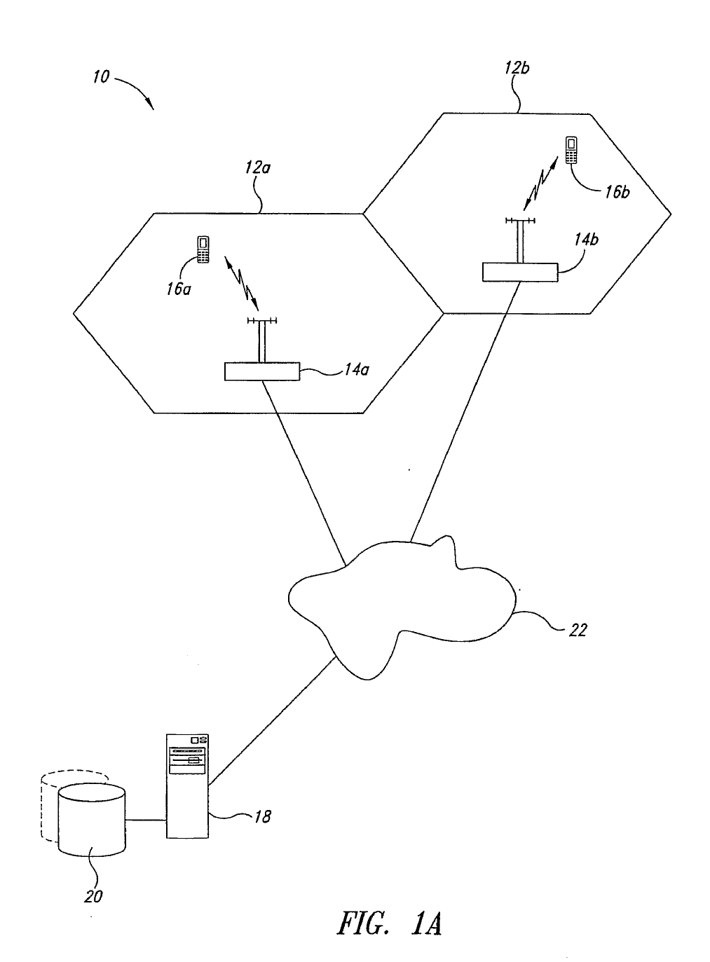

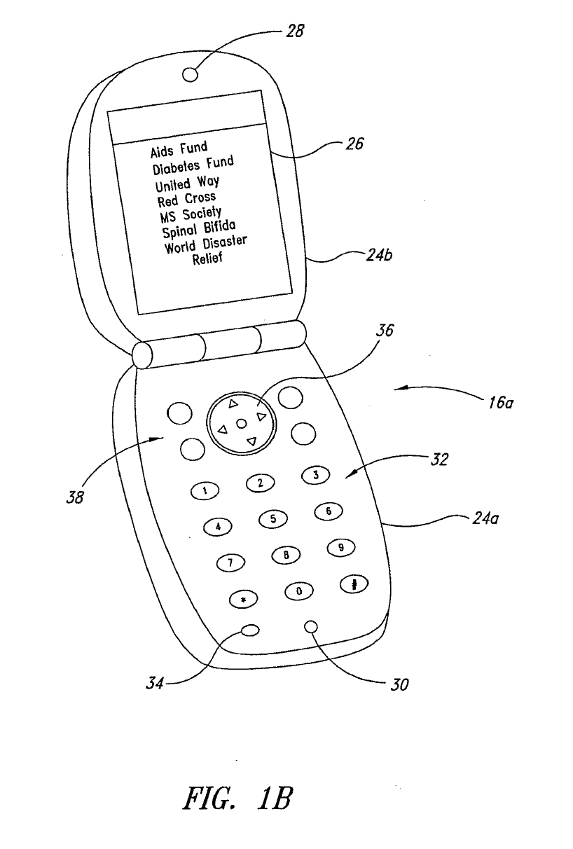

FIG. 1A shows a telecommunications environment 10 such as a cellular phone system including a number of cells 12a, 12b and respective base stations 14a, 14b used to provide wireless communications to mobile communication devices 16a, 16b. The telecommunications environment 10 may include a donation server 18 and database 20 configured to implement a donation system as described in detail below. The donation server 18 may communicate with the base stations 14a, 14b via a network 22 which may take any of a variety of forms including wired networks such as POTS or Ethernet and/or wireless networks such as a network provided under the GSM, PCS, TDMA, CDMA, GPRS, EDGE, or any of the IEEE 802.x wireless protocols (e.g. 802.11x, 802.16).

The donation server 18 may also communicate with one or more telecommunications service provider systems or services, for example with the home location register (HLR) and/or accounting or billing server. In some embodiments, the donation server 18 may be owned, controlled and/or operated by the telecommunications service provider. In this embodiment, the donation server 18 is owned, controlled and/or operated by an entity other than the telecommunications service provider, for example a charity or umbrella organization such as the United Way®.

FIG. 1B shows a mobile phone 16a according to one illustrated embodiment. The mobile phone 16a may include a clamshell type housing having a lower section 24a and an upper section 24b. The upper section 24b may include a display 26, such as a liquid crystal display (LCD), and may include a speaker 28. The display 26 typically has relatively small dimensions, for example two inch by two inch or smaller. The lower portion 24a of the housing includes a speaker 30, as well as a number of user actuable controls. The controls may include keys of a standard keypad 32, each key corresponding to a respective one of the digits 0-9 and to two special symbols * and #, commonly found on keypads associated with telephones. The mobile phone 16a may also include an ON/OFF switch, button key 34.

The mobile phone 16a may further include one or more user input devices operable for identifying and/or selecting items or icons displayed on the display 26. For example, a scrolling mechanism such as joystick or rocker switch 36 may allow the user to scroll a cursor displayed in the display 26 to identify an item or icon. For example, the rocker switch 36 may toggle between two opposed directions, allowing the user to scroll a cursor in two opposed directions in the display 26. Alternatively, the rocker switch 36 may toggle in more than two opposed directions. For example, the rocker switch 36 may toggle forward, back, and left, right, allowing a user to scroll top, bottom, left, right, in the display 26, respectively. The rocker switch 36 may also be selectively actuable to select an item or icon indicated via the scrolling in the display 26. For example, the rocker switch 36 may be depressed to select an identified item or icon. The mobile phone 16a may further include additional keys 38, for example, operable to display menus. While the scrolling mechanism is illustrated and discussed as a joystick or rocker switch, the scrolling mechanism may take any of variety of other forms, including, for example, a set of two or more keys that bear a defined physical relationship to one another. For example, selection of the key bearing the legend 2 may move the cursor up in the display 26, while selection of the key bearing the legend 8 may move the cursor down. Likewise, selection o the key bearing the legend 4 may move the cursor left in the display 26, while selection of the key bearing the legend 6 may move the cursor right. Other keys, or key combinations are possible. Alternatively, scrolling may be implemented based on duration of key depressions or number of times a key is depressed in a given period (e.g. single versus double clicking).

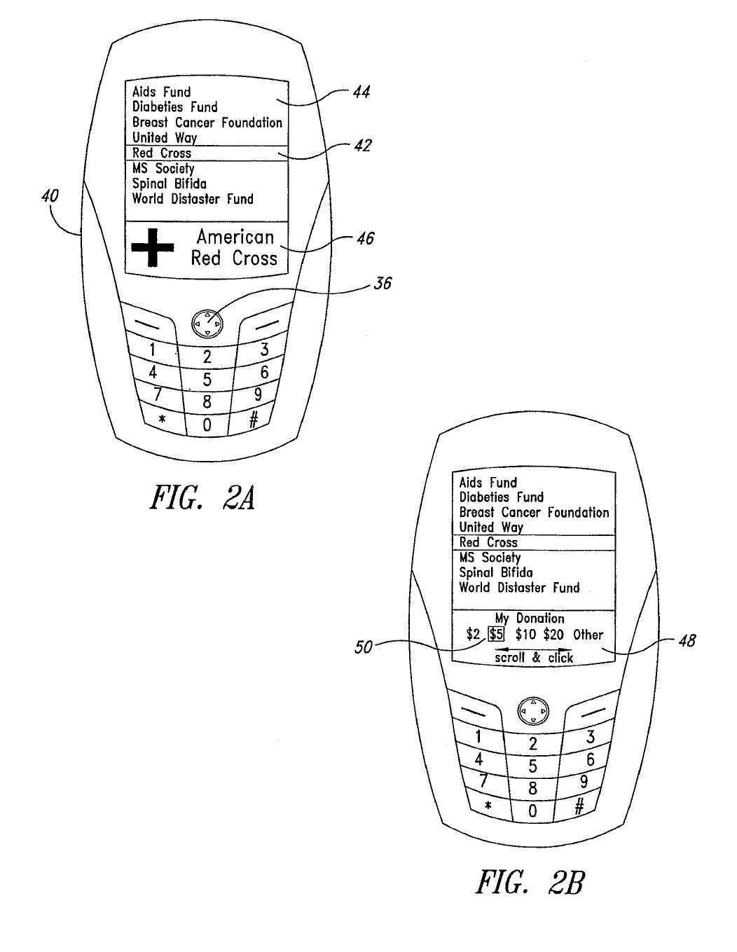

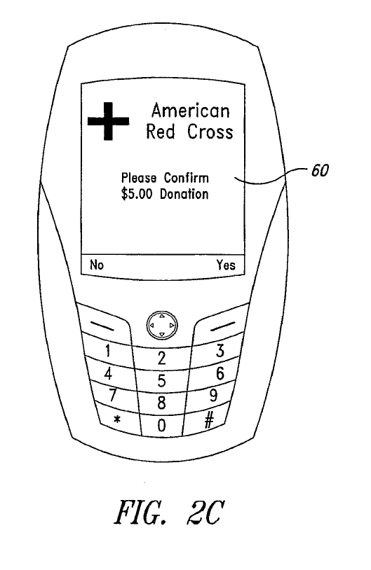

Although the mobile phone is shown with a clamshell-type housing, mobile phones with other types of housing can alternatively be utilized. For example, in FIG. 2A, a “candy bar” type housing 40 is illustrated. Although certain input methods are described for a mobile phone, on different mobile communication devices, different input methods such as a keyboard and touchpad on a laptop or a pen on a tablet device, may be utilized.

FIG. 2A is a front view of a mobile phone displaying a plurality of non-profit icons 44. As used herein and in the claims, the term icon means a visual representation, whether graphical, textual or a combination of graphical and textual. A user of the mobile phone can navigate the plurality of non-profit icons 44 by scrolling using the rocker switch 36 or other scrolling mechanism. As the mobile phone user scrolls through the plurality of non-profit icons 44, a single non-profit icon is highlighted 42. A user may click the highlighted non-profit icon and proceed to the donation screen as shown in FIG. 2B. In some embodiments, information about the non-profit and/or the non-profit's logo may be displayed or other made available via a request for additional information when the non-profit is highlighted. In some embodiments, the non-profit icons 44 may resemble the non-profit's logo. Information may include the mission statement of the non-profit, any serious needs, how long the non-profit has been around, etc. Similarly, an advertisement, possibly unrelated to the non-profit may be displayed. Advertisement space may help offset the cost of providing the donation system in some embodiments.

In one embodiment, multiple non-profits may be selected. If multiple profit icons are selected, the method allows a potential donor to proceed to the donation screen for each non-profit. Multiple non-profits icons may be selected by pressing a particular key such as * or # or combination of keys.

FIG. 2B is a front view of a mobile phone displaying the donation screen. The screen displays one or more possible donation icons 48 for the indicated non-profit to the user or potential donor. The user manipulates the rocker switch 36 or other scrolling mechanism to indicate the donation, represented by the donation icon, that the donor wishes to make by highlighting a selected donation 50. In some embodiments, an option for a user to fill in an arbitrary amount may be available. The arbitrary amount may be required to be over some minimum amount (e.g. one dollar) and/or may require minimum increments (e.g., dollars but not cents). An option to cancel is provided in a number of embodiments. In some embodiments, the portion of the donation actually given to the non-profit is indicated. Similarly, in some embodiments, the portion of the donation that actually goes to the non-profit's mission versus overhead or other expenses is indicated. In some embodiments, the donation screen takes up the entire display, instead of a portion of the display as shown in FIG. 2B.

FIG. 2C is a front view of a mobile phone showing a confirmation screen 60. The user is presented with the option to confirm the donation or cancel the donation. By pressing an appropriate key, such as Y (a.k.a. legend 9) for Yes and Confirm and N (a.k.a. legend 6) for No or Cancel, the donor can confirm the donation. In other embodiments, the user may be able to scroll between yes or no. The user has an option to cancel a donation if the donation was selected by accident or the donors choose the wrong donation on the donation screen. In some embodiments, no confirmation screen is utilized.

Although not illustrated a thank you screen may be shown in some embodiments immediately after confirmation. Although in other embodiments, the donor may be thanked at a subsequent time.

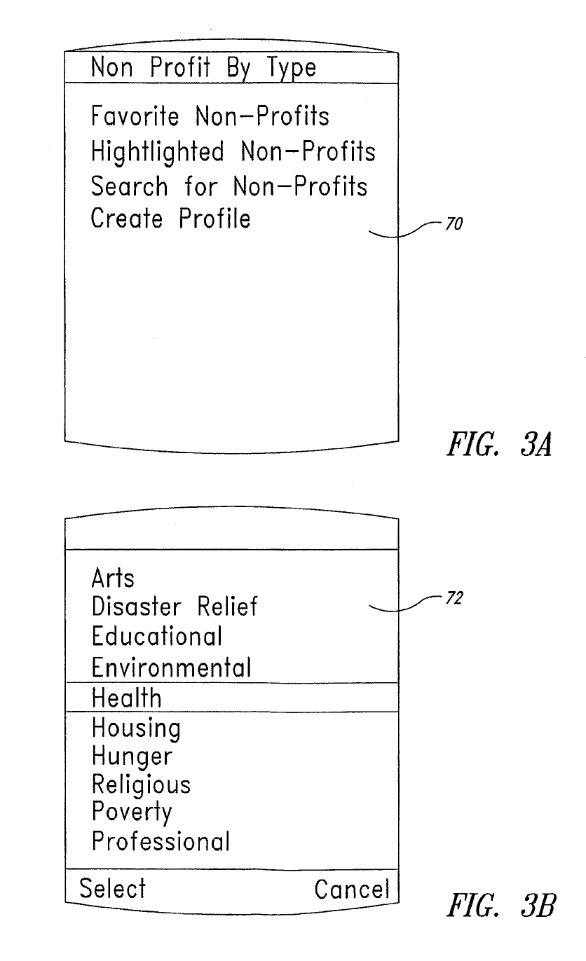

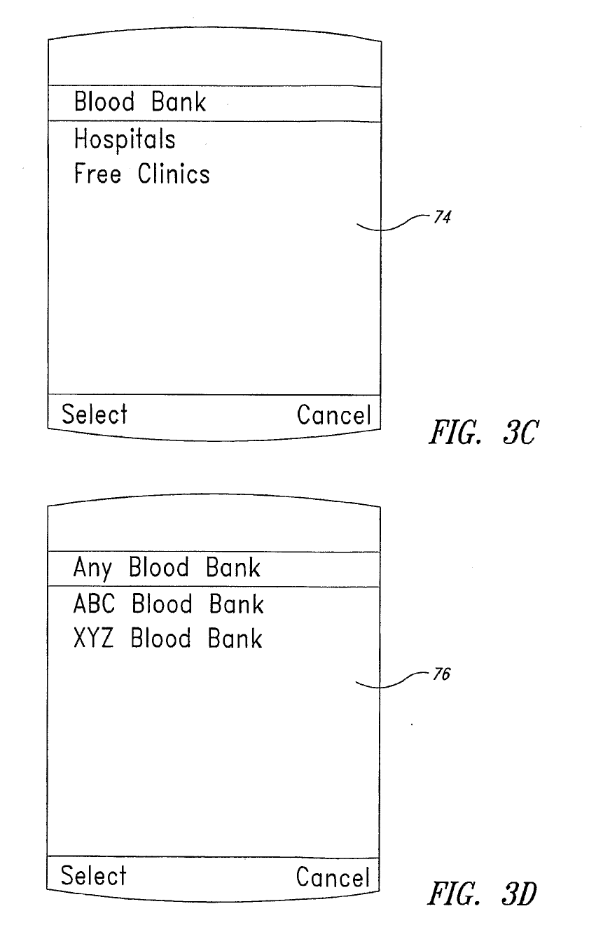

In some embodiments, as illustrated in FIGS. 3A-3E, the non-profits are organized into categories to make finding a particular non-profit or cause easy, when a large number of non-profits is present. FIG. 3A shows a top-level menu 70 of the donation system. A user may scroll through the list using the rocker switch 36 or other scrolling mechanism. Additional optional features are shown in FIG. 3A such as favorite and/or featured non-profits. These additional options may also be selected if available in that embodiment. When the “Non-profit by Type” option is selected, the user is presented with the topic area screen 72 in FIG. 3B.

In FIG. 3B, the potential donor is presented with a number of topic areas. In other embodiments, the user may be faced with more or less topic areas. For example, technology may be an additional topic area. The user can use the rocker switch 36 or the keypad 32 to highlight a particular topic area and select (e.g., click on) it. After the potential donor selects the “Health” topic area, the potential donor is presented with all the types of health-related non-profits screen 74 shown in FIG. 3C. The user may now use the rocker switch 36 or keypad 32 to navigate to and select a particular type of non-profit within a topic area. After the potential donor selects and clicks on a type of non-profit, the potential donor is presented with a screen 76 containing non-profits within that type as shown in FIG. 3D. Once again, the potential donor uses the rocker switch 36 or keypad 32 to highlight an item and select (e.g., click on) the item.

In some embodiments, as shown in FIG. 3E, some non-profits may have a screen 78 that further divides donations based on the type of donation to it depending on the individual non-profit's needs. The potential donor selects the type of donation by using the rocker switch 36 and finally proceeds to the donation screen. Also, FIG. 3E illustrates a non-monetary donation. In addition, to money and bodily fluids or organs, in-kind donations and volunteer time may be donated via the invention. Usually, non-monetary donations will be received directly from the donor and all of the donation will go to the non-profit. This donation will likely take place offline and in-person as with a blood donation or volunteer time. However, some non-monetary donations such as airline miles or reward points may be transferred to the non-profit via interactions with the airline or company associated with the miles or points, respectively. When potential donors wish to donate this type of non-monetary donation, the donor may be asked for a username and password to authenticate the user and allow the appropriate company to transfer the miles or points on behalf of the donor to the indicated non-profit.

In some embodiments, it may not be necessary to navigate as many screens to drill down to a particular non-profit. For example, the types of non-profits within a topic area may not be needed depending on the number of non-profits within that topic area. Advertisement, logos, images or information about causes may be displayed in various embodiments while navigating the non-profits.

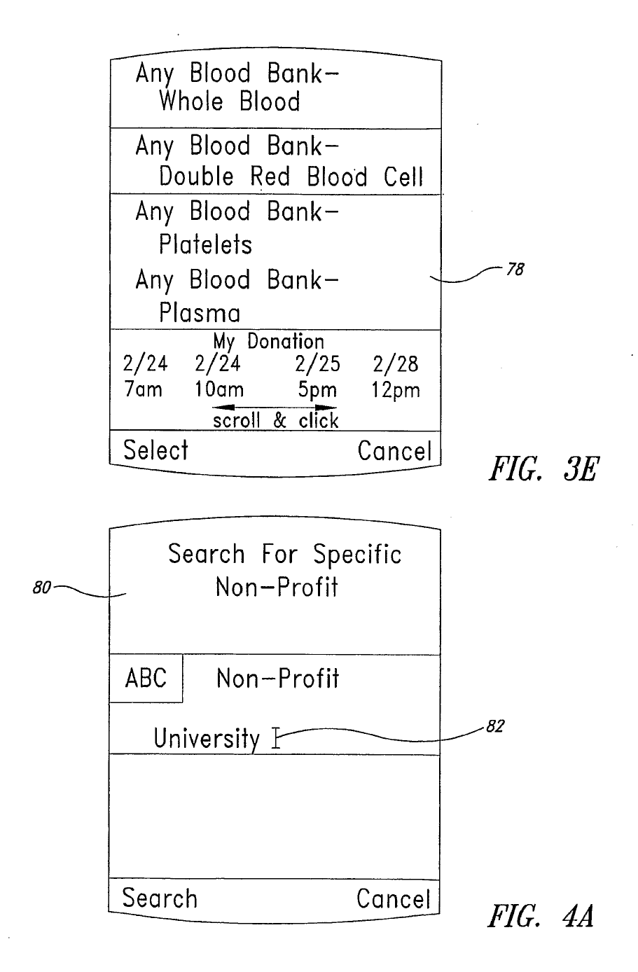

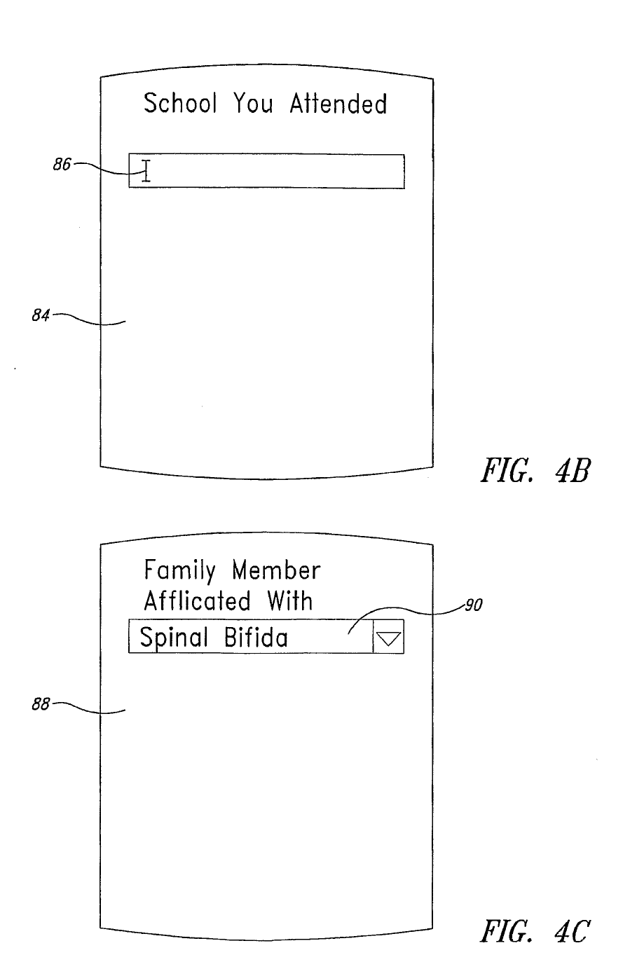

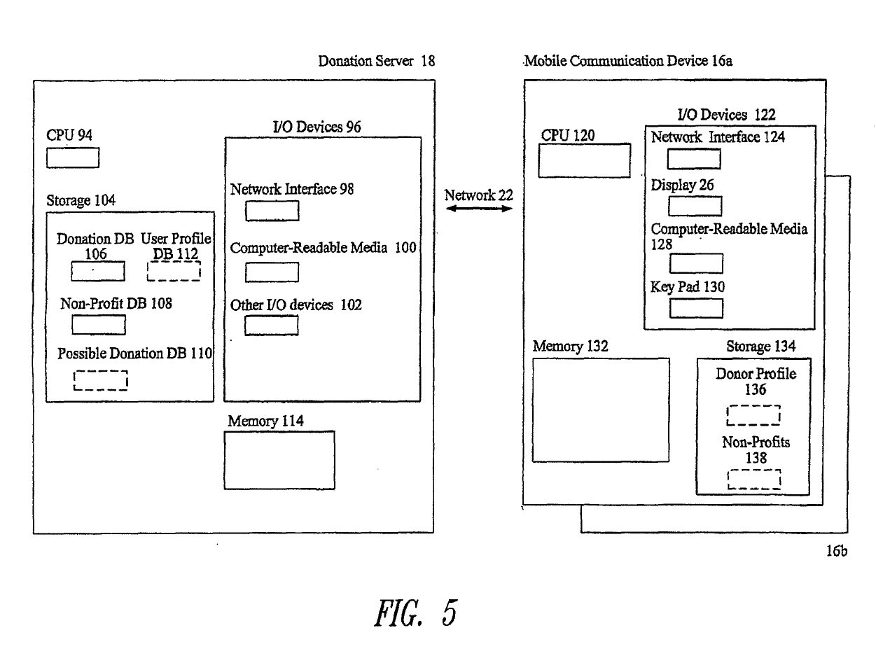

FIGS. 4A-4C illustrate features that may be available in some embodiments. FIG. 4A demonstrates a feature 80 that allows a mobile communication device user to search for a specific non-profit. When the plurality of non-profits icons is large or when it is hard to categorize a non-profit (e.g. the non-profit has a broad range of activities or a non-profit is generally a fundraising organization for other non-profits), it may be hard to find a specific non-profit without a search feature. The user is presented with a text entry box 82 and a button to click to initiate the search. The user may also cancel searching for a particular charity. When the search is initiated, the mobile communication device searches through the non-profits and displays one or more non-profits that match the search, if any. In some embodiments, the non-profits on the donation server 18 are searched as well and then displayed.

FIGS. 4B and 4C illustrate an ability to learn more about the potential donor to be able to personalize the donation system and potentially maximize donations to the causes the potential donor cares about. Such personalization may include creating a favorite list of non-profits, rearranging non-profits so that certain non-profits are placed farther up on the display of the plurality of non-profits icons, or notifying the software as to when the user should be asked to donate.

In particular, FIG. 4B illustrates a screen 84 that allows the potential donor to type in the name of the school such as a college or university that the donor attended. The name is typed into a text box 86. Similarly, in FIG. 4C, the potential donor is shown a screen 88 and asked about health conditions that a family member may be affiliated with. As an alternative method of entry of information about the donor, the potential donor is shown a drop down box 90. The questions presented in FIGS. 4B and 4C are merely representative. Additional questions may be asked to determine the motivations for donating, the non-profits the potential donor is likely to donate to, the time to ask for those donations, any matching donation programs available to the donor, and contact information (e.g. email) for the potential donor or donors that cannot be determined by the communications coming from the mobile communication device. The personalizations are stored in a user's profile, which may be stored on the donation server 18 in the User Profile DB 112 and/or the mobile communication device 16a.

FIG. 5 is a block diagram illustrating a system suitable for executing the donation system. The donation server 18 is connected via the network 22 to mobile communication device 16a. The donation server 18 has a CPU 94, memory 114, I/O devices 96 and storage 104. The I/O devices 96 include a network interface 98, computer-readable media 100, and other I/O devices 102. The donation server 18 may have many databases including a Donation DB 106, Non-Profit DB 108, Possible Donation DB 110, and optionally a User Profile DB 112. When indications of donations are received from the mobile communication device 16a, the donations are recorded in the Donation DB 106. In some embodiments, the plurality of non-profits icons to be displayed is received from the donation server 18 and the Non-Profit DB 108. Similarly, in one embodiment, the plurality of possible donations is received from the donation server 18 and the Possible Donations DB 110. The databases may store data in text files (e.g. comma delimited text files), various data structures, or may store data in more sophisticated embodiments in a database server. In other embodiments, the databases may be located on a database server that is connected over a network to the donation server.

The mobile communication device 16a has a CPU 120, memory 132, I/O device 122, and storage 134. I/O devices 122 on the mobile communication device 16a include a network interface 124, keypad (including a rocker switch or other scrolling mechanism) 130, and computer readable media 128 and a display 26. In some embodiments, the mobile communication device 16a may store a potential donor profile 136. In some embodiments, non-profits 138 are stored on the mobile communication device 16a. In some embodiments, non-profits are stored on the mobile communication device 16a and the donation server 18.

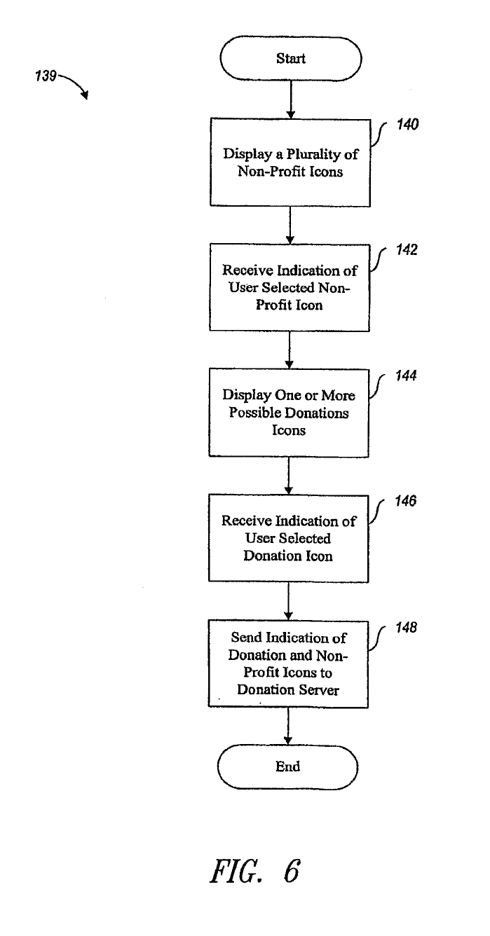

FIG. 6 is a flow diagram showing a method 139 of making a donation according to one illustrated embodiment. The potential donor indicates that she wants to donate to a non-profit and the donation system is started. At 140, a plurality of non-profits icons is displayed to the potential donor. At 142, the potential donor then selects a non-profit icon as described above. At 144, one or more possible donation icons are displayed to the potential donor. The potential donor selects a donation icon at 146, which is received by the donation system. At 148, an indication of the donation and the non-profit is sent to the donation server. Once received by the donation server, it may be used for further processing such as emailing the non-profit or for purposes of receiving the donation.

Non-profits include charities as well as other not-for-profit organizations such as state universities and political action committees. In other words, non-profits are broader than 501(c)(3) organizations.

There are many manners in which a monetary donation can be received. In one embodiment, the mobile communication provider's may bill the donation on their bill. Examples of the mobile communication provider include but are not limited to cell phone companies (such as Cingular, Sprint/Nextel, Verizon Wireless) and companies that offer hotspot access (such as T-Mobile and Boingo). In some embodiments, the donation may be able to be charged to a credit card or an electronic draft may be performed taking the money out of checking or savings account. An electronic draft is often cheaper to process and hence favored over the credit card for cost reasons. However, potential donors may feel more comfortable donating using a credit card.

In some embodiments, after the donor has made a donation, the donor is sent a receipt. The receipt may be an SMS or MMS message sent to the mobile communication device. Alternatively, the receipt may be sent by email to the mobile communication device's computer. A receipt may be only sent to a selected group of donors such as donors over a certain dollar amount. The receipt may be useful for tax purposes.

In addition to currently giving a one-time donation, donations may in some embodiments be a one-time donation scheduled for a specific time in the future or may be recurring. Recurring donations reoccur periodically such as monthly, seasonally, or semiannually. A user-selectable icon may be selected to make a donation recurring.

In some embodiments, in order to encourage donations, after or during a triggering event, the user of the mobile communication device may be notified about their ability to make a donation using the mobile communication device. This notification may be an SMS or MMS message or an automatic display of the plurality of non-profits icons based on a special command sent to the mobile communication device, such as a command sent via a special SMS message. Examples of triggering events include, but are not limited to, incidents of national significance (e.g. terrorist attacks, disease pandemics), natural disasters, national holidays (e.g. Thanksgiving or Christmas, New Year's Eve), and benefit concerts. The notification may also include additional information such as the tax advantages to donating if applicable.

In some embodiments, matching donations may be possible. The communications provider, a private foundation, or the donor's employer may provide a matching donation. Often the matching donation will be up to a certain dollar amount and may not be a dollar for dollar match. For example, the donation may be a 50% match, where only 50 cents is matched for every dollar donated by the donor. In some embodiments, the matching donation may be an in-kind donation such as minutes from the communications provider. In one embodiment, a random number generator would be utilized to determine which donations get matched. If the random number matches a preselected number or numbers, the donation will be matched. In other embodiments, matching donations may be available only to a selected group of non-profits such as 501 (c)(3)s or only ones affiliated with a particular cause (e.g. AIDS relief or Hurricane Katrina relief). In these embodiments, visual indications may be displayed to indicate if a matching donation is possible. Indications may be a symbol or text indicating the matching. For example, “X2” may be shown for a dollar for dollar match. In devices that have the capability, a sound or other non-visual indication may be utilized in some embodiments. Different colors or other highlighting may alternatively be used to indicate that matching is available.

In some embodiments, after a predetermined period of time such as a month after the donation is received, a notification is sent to the donor thanking him or her for their donation. This notification could be sent via SMS or Multimedia message service (“MMS”) to the mobile communication device. Alternatively, since it is common to charge for SMS or MMS messages, the thank you notification may be sent via email using contact information from the communication provider or supplied from the user's profile. In some embodiments, in January, an email or SMS message may be sent indicating all donations made using the mobile communication in the past year, which is useful for both budgeting and tax purposes. In some embodiments, the statement of donations may only be sent to donors over some threshold dollar amount.

The above description of illustrated embodiments, including what is described in the Abstract, is not intended to be exhaustive or to limit the invention to the precise forms disclosed. Although specific embodiments of and examples are described herein for illustrative purposes, various equivalent modifications can be made without departing from the spirit and scope of the invention, as will be recognized by those skilled in the relevant art. The teachings provided herein of the invention can be applied to other suitable communications systems and devices, not necessarily the exemplary wireless communications devices and donation program generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure. Computer programs may be programmed in various manners well known in the art such as J2ME and Brew.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. Aspects of the invention can be modified, if necessary, to employ systems, circuits and concepts of the various patents, applications and publications to provide yet further embodiments of the invention.

These and other changes can be made to the embodiments in light of the above-detailed description. In general, in the following claims, the terms used should not be construed to limit the invention to the specific embodiments disclosed in the specification and the claims, but should be construed to include all systems, devices, user interfaces and games that operate in accordance with the claims. Accordingly, the invention is not limited by the disclosure, but instead its scope is to be determined entirely by the following claims.

U.S. patent application Ser. No. 11/134,992 filed May 23, 2005 and U.S. provisional application Ser. No. 60/723,466 filed Oct. 4, 2005 are incorporated herein by reference, in their entirety.

Those skilled in the art will also appreciate that in some embodiments the functionality provided by the routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

In addition, while certain aspects of the invention are presented below in certain claim forms, the inventor contemplates the various aspects of the invention in any available claim form. For example, while only some aspects of the invention may currently be recited as being embodied in a computer-readable medium, other aspects may likewise be so embodied.

I/We claim:

1. A method of making donations, comprising:
displaying a plurality of user-selectable non-profit icons on a mobile communication device to a potential donor, the non-profit icons representing respective non-profit entities;
receiving an indication of a user selected non-profit icon selected from the plurality of displayed non-profit icons;
displaying one or more possible donation icons representing donations to the indicated non-profit;
receiving an indication of a user selected donation icon selected from the one or more possible donations; and
sending an indication of the user selected donation icon and user selected non-profit icon to a donation server.

2. The method of claim 1, further comprising:
receiving the indicated donation represented by the user selected donation icon; and
providing at least a portion of the donation given to the indicated non-profit.

3. The method of claim 2 wherein displaying one or more possible donation icons includes displaying one or more donation icons representing monetary amounts.

4. The method according to claim 3 wherein receiving the indicated donation occurs with the payment of a mobile communication device user's bill for communication services for the mobile communication device.

5. The method according to claim 3 wherein receiving the indicated donation involves charging the donation to the communication device user's credit card.

6. The method according to claim 3 wherein receiving the indicated donation involves creating an electronic draft from a checking account.

7. The method according to claim 3 wherein receiving the indicated donation involves creating an electronic draft from a saving account.

8. The method according to claim 3, further comprising:
displaying an indicator indicative of a portion of the donation actually provided to the non-profit along with the one or more possible donation icons.

9. The method according to claim 3, further comprising:
displaying a user-selectable icon, selection of which makes donation a recurring donation.

10. The method according to claim 1 wherein the non-profit is a charity.

11. The method according to claim 1, further comprising:
after receiving the indication of the indicated non-profit, displaying to the mobile communication device user information about the indicated non-profit.

12. The method according to claim 1, further comprising:
displaying the logo of the indicated non-profit while the user is selecting a non-profit icon from the plurality of non-profit icons.

13. The method according to claim 3, further comprising:
providing an indication that a monetary donation will be matched.

14. The method according to claim 1, further comprising:
displaying one or more icons indicative of respective non-monetary donations.

15. The method according to claim 14 wherein at least one of the non-monetary donations is volunteer time.

16. The method according to claim 14 wherein at least one of the non-monetary donations is an in-kind donation.

17. The method according to claim 1, further comprising:
notifying the mobile communication device user of the ability to make a donation using the mobile communication device after a triggering event.

18. The method according to claim 17 wherein the triggering event is at least partially based on information known about the potential donor.

19. The method according to claim 1, further comprising:
receiving the plurality of non-profit icons to display from the donation server.

20. The method according to claim 19, further comprising:
receiving the one or more possible donation icons from the donation server.

21. The method of claim 1 wherein displaying of the plurality of non-profit icons includes displaying the non-profit icons categorized into groups of related non-profits.

22. The method of claim 1, further comprising:
displaying an image related to the non-profit when the user is selecting a non-profit.

23. The method of claim 1 wherein sending an indication of the donation includes sending an SMS message.

24. The method of claim 1 wherein sending an indication of the donation includes sending a signal over WAP.

25. The method of claim 2 wherein receiving the indicated donation occurs offline.

26. The method of claim 1, further comprising:
providing a thank you message to the donor for the donation.

27. The method of claim 26 wherein providing the thank you message to the donor is performed at some predetermined time after the donation.

28. The method of claim 1, further comprising:
after receiving an indication of the donation, confirming the user selected donation icon before sending the user selected donation icon and user selected non-profit icon to the donation server.

29. The method of claim 1, further comprising:
sending the donor a receipt for the donation.

30. A mobile computing device for making donations, comprising:
a memory;
a first module, when executed in memory, capable of displaying a plurality of user selectable non-profit icons on a mobile communication device to a communication device user, the non-profit icons representing respective non-profit entities;
a second module, when executed in memory, capable of receiving an indication of a user selected non-profit icon from the plurality of displayed non-profit icons;
a third module, when executed in memory, capable of displaying one or more possible donation icons representing donations to the indicated non-profit;
a fourth module, when executed in memory, capable of receiving an indication of a user selected donation icon selected from the one or more possible donations; and
a fifth module, when executed in memory, capable of sending an indication of the user selected donation icon and user selected non-profit icon to a donation server.

31. The computing device of claim 30 wherein displaying one or more possible donation icons includes displaying one or more donation icons representing monetary amounts.

32. The computing device of claim 31, further comprising:
displaying an indicator indicative of a portion of the donation actually provided to the non-profit along with one or more possible donation icons.

33. The computing device of claim 30, further comprising:
a sixth module, when executed in memory, capable of after receiving the indication of the indicated non-profit, displaying on the mobile communication device user information about the indicated non-profit.

34. A computer-readable medium whose contents allow a mobile handheld device to provide a donation to one of a plurality of non-profits by:
displaying a plurality of user selectable non-profit icons on a mobile communication device to a communication device user, the non-profit icons representing respective non-profit entities;
receiving an indication of a user selected non-profit icon selected from the plurality of displayed non-profits;
displaying one or more possible donation icons representing donations to the indicated non-profit;
receiving an indication of a user selected donation icon selected from the one or more possible donations; and
sending an indication of the user selected donation icon and user selected non-profit icon to a donation server.

35. The computer-readable medium of claim 34 wherein displaying one or more possible donation icons includes displaying one or more donation icons representing monetary amounts.

36. The computer-readable medium of claim 35, further by:
displaying an indicator indicative of a portion of the donation actually provided to the non-profit along with the one or more possible donation icons.

37. The computer-readable medium of claim 35, further by:
providing an indication that a monetary donation will be matched.

38. A mobile computing device for making donations, comprising:
a memory;
means for displaying a plurality of user selectable non-profit icons to a communication device user, the non-profit icons representing respective non-profit entities;
means for receiving an indication of a user selected non-profit icon from the plurality of displayed non-profit icons;
means for displaying one of more possible donation icons representing donations to the indicated non-profit;
means for receiving an indication of a user selected donation icon selected from the one or more possible donations; and
means for sending an indication of the user selected donation icon and user selected non-profit icon to a donation server.
